(19) United States
(12) Patent Application Publication
(10) Pub. No.: US 2006/0126331 A1
(43) Pub. Date: Jun. 15, 2006

(54) PACKAGING STRUCTURE FOR A LIGHT SOURCE OF AN OPTICAL MOUSE

(76) Inventor: Mao-Hsiung Chien, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/162,157

(22) Filed: Aug. 31, 2005

(30) Foreign Application Priority Data
Dec. 10, 2004 (TW) 093138505

(51) Int. Cl. F21V 33/00

(52) U.S. Cl. 362/253; 345/166; 362/800

(57) ABSTRACT

A packaging structure for a light source of an optical mouse includes a holder, a first lead frame, a second lead frame, a plurality of pins, a dispenser, a chip and a transparent housing. The first lead frame and the second lead frame are disposed on the holder. The plurality of pins are disposed on the holder and coupled to the first lead frame and the second lead frame. The dispenser is coupled to the first lead frame. The chip is disposed on the dispenser and coupled to the second lead frame. The transparent housing is formed on the holder and forms an isolated space with the holder. The chip is located inside the isolated space. The packaging structure isolates the chip from the ambient environment with the transparent housing and provides the chip with better protection. The transparent housing controls the light emitted from the chip.

### BACKGROUND OF THE INVENTION

1. Field of the Invention

The present invention relates to a packaging structure for a light source of an optical mouse, and more particularly, to a packaging structure for a light source of an optical mouse capable of adjusting light using a transparent housing.

2. Description of the Prior Art

Traditional corded, ball-based mechanical mice are simple both in design and operational principles. They have worked well since the invention of the computer mouse but suffered from two insurmountable shortcomings: those annoying cords always seem to get in the way, and the tracking ball and the motion-detecting axes, continually gummed up with dirt, require frequent cleaning and thus cause inconvenience for users. With the rapid development of the computer industry, the traditional mechanical mice are gradually being replaced by optical mice using optical sensors that offer significantly improved precision, better tracking, and smoother cursor movement. With reasonable prices and longer lifetime, optical mice are bound to become the mainstream of the market.

Optical mice usually adopt optical devices such as light emitting diodes (LEDs) or laser diodes (LDs) as light sources. The packaging of the optical devices directly influences the performance of the optical mice. A packaging technique called transistor outline can (TO-Can) package features advantages such as good minimization, low cost, high throughput and convenient plug-and-play. Therefore, TO-can techniques are widely used in optical mice.

Please refer to FIG. 1 for a prior art packaging structure 100 for a light source of an optical mouse. The packaging structure 100 includes a chip 10, a wire-bond 12, two pins 14, a circular metal housing 16 and a holder 20. The chip 10 is disposed on the holder 20 in a die bond process, and is electrically connected to the pins 14 in a wire-bond process. Finally, the circular metal housing 16 is disposed on the holder 20. In the prior art packaging structure 100, the chip 10 is exposed to the air and thus easily affected by humidity, temperature or dust during operations. Therefore, the prior art packaging structure 100 has poor reliability.

Please refer to FIG. 2 for a diagram illustrating the operation of the packaging structure 100. Since the chip 10 of the packaging structure 100 is exposed to the air, two lenses 18 are required for controlling the direction and angle of the light emitted from the chip 10 so that a sensor 32 can detect signals. The extra disposition of the lenses 18 in the prior art packaging structure 100 adds to the manufacturing costs of the optical mouse, as well as complicates the production flow.

In the prior art packaging structure 100, the chip 10 for emitting light is exposed to the air. Optical mice having the packaging structure 100 are easily affected by the ambient environment during operation and thus have poor reliability. The two lenses used for controlling the direction and angle of the emitted light also increase the manufacturing costs and require extra disposition steps. Therefore, optical mice having the prior art packaging structure have poor reliability and high manufacturing costs.

### SUMMARY OF THE INVENTION

It is therefore a primary objective of the claimed invention to provide a packaging structure for a light source of an optical mouse in order to solve the problems of the prior art.

The claimed invention discloses a packaging structure for a light source of an optical mouse comprising a holder, a first lead frame, a second lead frame, two pins, a dispenser, a chip and a transparent housing. The first lead frame and the second lead frame are disposed on the holder. The two pins are disposed on the holder, each of which are coupled to the first and second lead frames respectively. The dispenser is coupled to the first lead frame. The chip is disposed on the dispenser and wire-bonded to the second lead frame. The transparent housing is disposed on the holder, wherein the chip is disposed in an isolated space formed between the transparent housing and the holder.

These and other objectives of the present invention will no doubt become obvious to those of ordinary skill in the art after reading the following detailed description of the preferred embodiment that is illustrated in the various figures and drawings.

### BRIEF DESCRIPTIONS OF THE DRAWINGS

FIG. 1 shows a prior art packaging structure for a light source of an optical mouse.

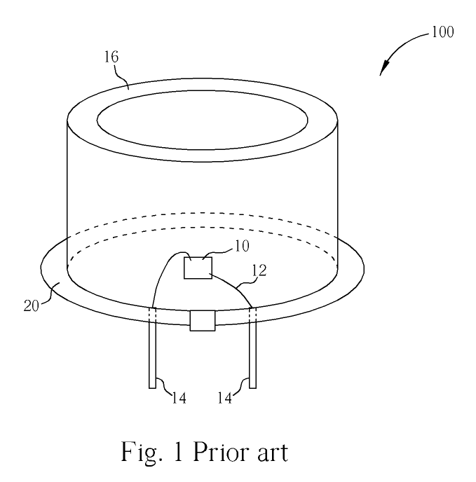

FIG. 2 is a diagram illustrating the operation of the packaging structure of FIG. 1.

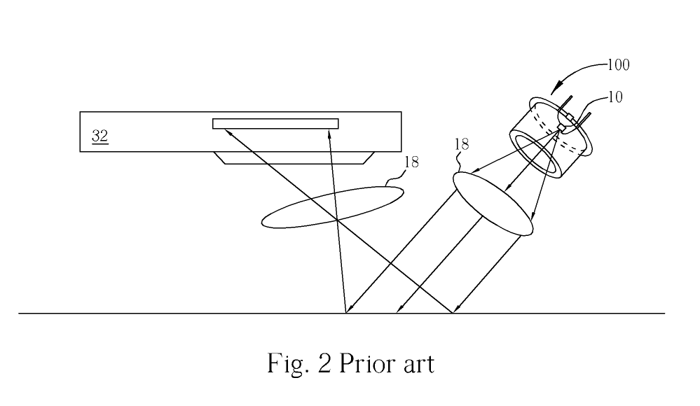

FIG. 3 shows a packaging structure for a light source of an optical mouse according to a first embodiment of the present invention.

FIG. 4 is a diagram illustrating the operation of the packaging structure of FIG. 3.

FIG. 5 shows a packaging structure for a light source of an optical mouse according to a second embodiment of the present invention.

FIG. 6 shows a packaging structure for a light source of an optical mouse according to a third embodiment of the present invention.

FIG. 7 shows a packaging structure for a light source of an optical mouse according to a fourth embodiment of the present invention.

### DETAILED DESCRIPTION

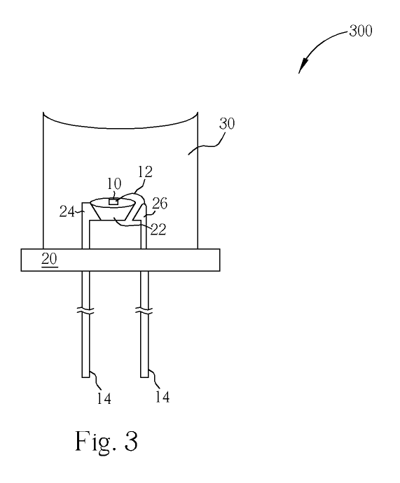

Please refer to FIG. 3 for a packaging structure 300 for a light source of an optical mouse according to a first embodiment of the present invention. The packaging structure 300 includes a chip 10, a wire-bond 12, two pins 14, a holder 20, a dispenser 22, a first lead frame 24, a second lead frame 26 and a transparent housing 30. The first lead frame 24 and the second lead frame 26 are disposed on the holder 20 and coupled to the pins 14. The dispenser 22 is coupled to the first lead frame 24. The chip 10, disposed on the dispenser 22, is coupled to the second lead frame 26 via the wire-bond 12 by in a wire-bond process. The transparent housing 30 is formed on the holder 20 and forms an isolated space with the holder 20, in which the chip 10 is disposed. The transparent housing 30 includes a concave lens composed of epoxy, which can be formed in an injection molding process. The chip 10 can include optical devices such as light emitting diodes (LEDs) or laser diodes (LDs). The packaging structure 300 of the present invention isolates the chip 10 from the ambient environment with the transparent housing 30 and provides the chip 10 with a better protection from moisture or dirt. Hence, optical mice having the packaging structure 300 of the present invention have high reliability.

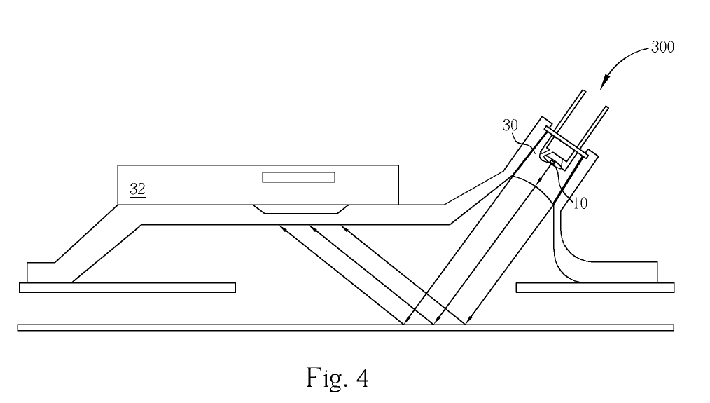

Please refer to FIG. 4 for a diagram illustrating the operation of the packaging structure 300. Since the transparent housing 30 includes a concave lens, its radiance can be controlled in an injection molding process for adjusting the direction and angle of the light emitting by the chip 10. The transparent housing 30 can provide the same function as the prior art packaging structure 100 without the extra lenses 18. Hence, optical mice having the packaging structure 300 of the present invention have lower manufacturing costs. Also, since the transparent housing 30 is formed in a same process together with other components of the packaging structure 300, optical mice having the packaging structure 300 of the present invention can be manufactured in a simpler production flow.

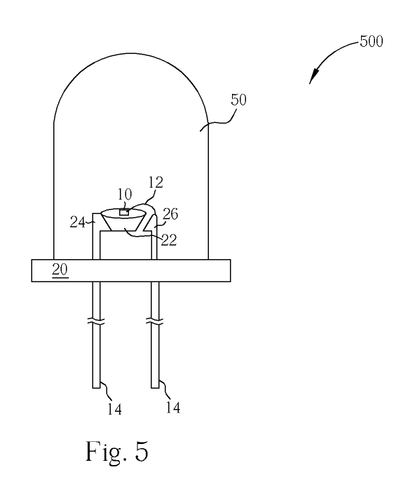

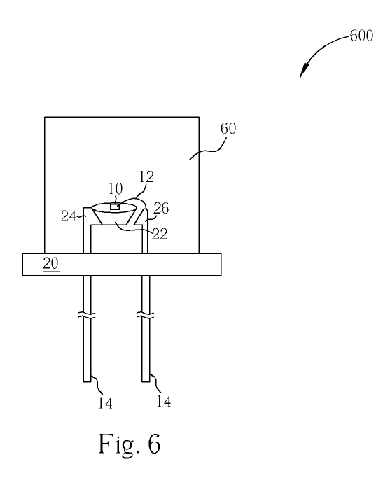

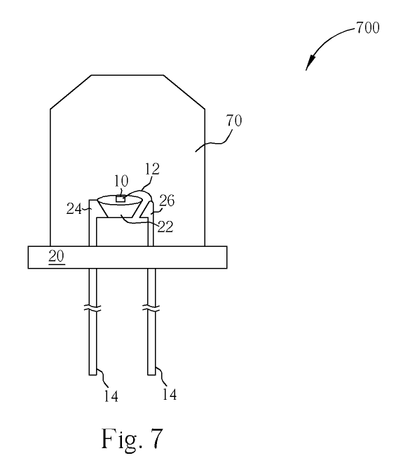

The transparent housing 30 of the packaging structure 300 can include a concave lens, or other lenses designed for different operating environments and chips. Please refer to FIG. 5 through FIG, 7. FIG. 5 shows a packaging structure 500 for a light source of an optical mouse according to a second embodiment of the present invention. A transparent housing 50 of the packaging structure 500 includes a convex lens whose radiance can be controlled in an injection molding process. FIG. 6 shows a packaging structure 600 for a light source of an optical mouse according to a third embodiment of the present invention. A transparent housing 60 of the packaging structure 600 includes a plane lens. FIG. 7 shows a packaging structure 700 for a light source of an optical mouse according to a fourth embodiment of the present invention. A transparent housing 70 of the packaging structure 700 includes a plurality of plane lenses with distinct normals. The transparent housing 70 can refract light and generate a plurality of light beams radiating towards different directions. Therefore, optical mice having the packaging structure 700 are particularly suitable for applications on surfaces having different reflective indexes. To conclude, the present invention includes transparent housings capable of controlling the direction and angle of the emitted light.

Each of the packaging structures 300, 500, 600 and 700 of the present invention can include two pins, or other amount of pins designed for different optical devices.

Compared to the prior art, the present invention isolates the chip from the ambient environment with the transparent housing, providing the chip with better protection and increasing the reliability of the chip. Hence, optical mice having the packaging structure of the present invention have higher reliability. By controlling the emitted light with the transparent housing, the present invention does not require extra lenses as in the prior art and thus reduces the efforts and costs of disposing the extra lenses. In conclusion, the present invention provides easy-producible, low-cost and reliable packaging structures for the light sources of optical mice.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packaging structure for a light source of an optical mouse comprising: holder;
a first lead frame and a second lead frame disposed on the holder;
two pins disposed on the holder, each of the two pins coupled to the first and second lead frames respectively;
a dispenser coupled to the first lead frame;
a chip disposed on the dispenser and wire-bonded to the second lead frame; and
a transparent housing disposed on the holder, wherein the chip is disposed in an isolated space formed between the transparent housing and the holder.

2. The packaging structure of claim 1 wherein the transparent housing includes a concave lens.

3. The packaging structure of claim 1 wherein the transparent housing includes a convex lens.

4. The packaging structure of claim 1 wherein the transparent housing includes a plane lens.

5. The packaging structure of claim 1 wherein the transparent housing includes a plurality of plane lenses with distinct normals.

6. The packaging structure of claim 1 wherein the transparent housing is epoxy.

7. The packaging structure of claim 1 wherein the transparent housing is formed in an injection molding process.

8. The packaging structure of claim 1 wherein the chip includes a laser diode.

9. The packaging structure of claim 1 wherein the chip includes a light emitting diode.
